(19) United States
(12) Patent Application Publication
(10) Pub. No.: US 2001/0052189 A1
(43) Pub. Date: Dec. 20, 2001

(54) Radius tools

(76) Inventor: Stewart Kreisler, Wakefield, MA (US)

Correspondence Address: TIMOTHY A. FRENCH, FISH & RICHARDSON P.C., 225 Franklin Street, Boston, MA, 02110-2804, US

(21) Appl. No.: 09/745,773

(22) Filed: Dec. 22, 2000

Related U.S. Application Data
(60) Provisional application No. 60/173,271, filed on Dec. 28, 1999.

(51) Int. Cl. B43L 7/10

(52) U.S. Cl. 33/473

(57) ABSTRACT

A tool for determining the radius, e.g., of a construction or other surface, such as a doorway arch or the like, has three arms. Each arm has a free end and defines an elongated slot through which a pivot pin is mounted. In one embodiment, arm free ends are engaged with an arch or other surface, and the arms and pivot pin are relatively adjusted until the same dimension is indicated on each arm. In another embodiment, the slots and the pivot pin define cooperatively interengaging teeth, and rotation of the pivot pin moves the arms until the free ends of all the arms engage the surface to indicate the surface radius. The radius tool may also have the form of a flexible arms wound from a spool.

### TECHNICAL FIELD

This application claims benefit of U.S. Provisional Application No. 60/173,271, filed Dec. 28, 1999.

This invention relates to tools for determining length of radius, e.g., of a construction or other surface, such as a doorway arch or the like.

### BACKGROUND

In construction, e.g. while renovating a home or apartment, and in other instances, it is desirable to determine the radius of a smoothly curved surface.

### SUMMARY

According to one aspect of the invention, a tool for determining length of radius for an arc or circle comprises at least three arms joined at a region of intersection along respective lengths of the arms by a pivot member defining a pivot axis. Each arm has an elongated body with a free end, and each arm is disposed in lengthwise adjustable relationship with the pivot member. The tool further comprises an indicator of the length of radius measured along at least one arm between the pivot axis and the free end of that arm.

Preferred embodiments of this aspect of the invention may include one or more of the following additional features. At least one of the three arms is adjustable lengthwise relative to the pivot axis independent of at least one other arm. Preferably, each arm is adjustable lengthwise relative to the pivot axis independent of each other arm. More preferably, each arm bears indicia of length measured from its respective free end. Each arm defines an elongated slot, and the pivot member comprises a pivot pin engaged in the slot of each arm. The arms are adjustable lengthwise in unison relative to the pivot axis. Preferably, the pivot member comprises an indicator of the length of radius measured between the pivot axis at a position of the pivot member along at least one arm and the free end of that arm. Each arm defines an elongated slot, and the pivot member comprises a pivot pin engaged in the slot of each arm. The slot of each arm further defines slot teeth disposed along the slot, and the pivot pin further defines pin teeth for cooperative interengagement with the slot teeth, whereby rotation of the pivot pin within the slots changes position of the pivot member along each arm, in unison varying the length of each arm from the pivot axis to the respective free ends. At least one arm is pivotable about the pivot axis relative to and independent of at least one other arm. Each arm is pivotable about the pivot axis relative to and independent of each other arm. At least one arm bears indicia of length measured from its respective the free end. Preferably, each arm bears indicia of length measured from its respective free end. The pivot member comprises an indicator of length measured between the pivot axis at a position of the pivot member along at least one arm and the free end of that arm. Each arm defines an elongated slot, and the pivot member comprises a pivot pin engaged in the slots of the arms. Preferably, each arm further defines slot teeth disposed along the slot, and the pivot member further defines pin teeth for cooperative interengagement with the slot teeth, whereby rotation of the pivot pin within the slots changes position of the pivot member along each arm, in unison varying the length of each arm from the pivot axis to the respective free ends. Preferably, each arm is flexible, and the pivot pin comprises a spool and rotation of the pivot pin changes position of the pivot member along each arm, in unison varying the length of each arm from the pivot axis to the respective free end.

According to another aspect of the invention, a tool for determining length of radius for an arc or circle comprises at least three arms joined at a region of intersection along respective lengths by pivot member defining a pivot axis. Each arm has an elongated body with a free end, and each arm is disposed in lengthwise adjustable relationship with the pivot member. Each arm is also adjustable lengthwise relative to the pivot axis independent of each other arm, and each arm bear indicia of length measured from its respective free end. Each arm defines an elongated slot, and the pivot member comprises a pivot pin engaged in the slot of each arm. The tool further comprises an indicator of length of radius measured along at least one arm between the pivot axis and the free end of that arm.

According to another embodiment of the invention, a tool for determining length of radius for an arc or circle comprises at least three arms joined at a region of intersection along respective lengths by a pivot member defining a pivot axis. Each arm has an elongated body with a free end, and each arm is disposed in lengthwise adjustable relationship with the pivot member, with the arms being adjustable lengthwise in unison relative to the pivot axis. Each arm defines an elongated slot, and the pivot member comprises a pivot pin engaged in the slot of each arm, the slot further defining slot teeth disposed along the slot, and the pivot member further defining pin teeth for cooperative interengagement with the slot teeth, whereby rotation of the pivot pin within the slots changes position of the pivot member along each arm, in unison varying the length of each arm from the pivot axis to the respective free ends. The tool further comprises an indicator of length of radius measured along at least one arm between the pivot axis and the free end of that arm.

According to yet another aspect of the invention, a tool for determining length of radius for an arc or circle comprises at least three arms joined at a region of intersection along respective lengths by a pivot member defining a pivot axis. Each arm has an elongated body with a free end, and each arm is disposed in lengthwise adjustable relationship with the pivot member, the arms being adjustable lengthwise in unison relative to the pivot axis. Each arm is flexible, and the pivot member comprises a spool, whereby rotation of the pivot pin changes the relative position of the pivot member along each arm, in unison varying the length of each arm from the pivot axis to the respective free ends. The tool further comprises an indicator of length of radius measured along at least one arm between the pivot axis and the free end of that arm.

According to still another aspect of the invention, a method for determining length of radius for an arc or circle with a tool comprising at least three arms joined at a region of intersection along respective lengths by a pivot member defining a pivot axis, each arm having an elongated body with a free end, and each arm being disposed in lengthwise adjustable relationship with the pivot member, and the tool further comprising an indicator of length measured along at least one arm between the pivot axis and the free end of that arm, the method comprising the steps of: placing the free end of at least one arm on the arc or circle for which length of radius is to be determined; adjusting the arms lengthwise relative to the pivot member until the free ends of the three arms are on the arc or circle and the axial lengths of three arms from the free end to the pivot axis are substantially equal; and determining the length of radius from the common xial length of the three arms.

The invention thus provides a simple tool for determining the length of radius for a curved surface, e.g., an arch surface during construction or renovation of a home or apartment. In another embodiment, the radius tool of the invention can be employed to quickly and accurately measure out circles and arcs of large dimension, e.g. as required for athletic playing fields in a number of sports. The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1 and 1A are a top plan view and a side view, respectively, of one embodiment of a radius tool of the invention.

FIGS. 2 and 2A are a top plan view and a side view of another embodiment of a radius tool of the invention.

FIG. 3 is a front perspective view of yet another embodiment of a radius tool of the invention.

Like reference symbols in the various drawings indicate like elements.

### DETAILED DESCRIPTION

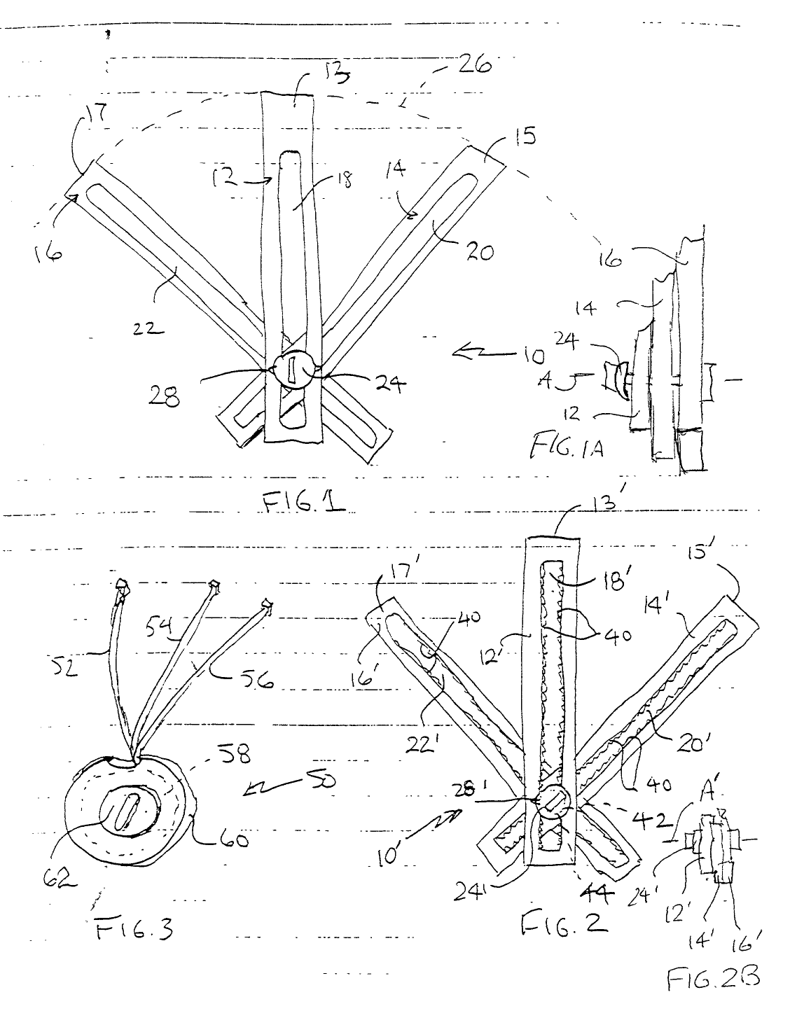

Referring to FIGS. 1 and 1A, in one embodiment, a radius tool 10 of the invention consists of a first arm 12, a second arm 14, and a third arm 16, each defining an elongated slot 18, 20, 22, respectively, through which is engaged a pivot pin 24. The arms may be formed of any suitable material, and the arms may be of any length suitable to the dimension of the task at hand. The arms 12, 14, 16 are marked with dimensions, e.g. inches or centimeters, along their lengths, beginning from the free ends 13, 15, 17, respectively.

To determine the radius of a doorway arch 26 (indicated in dashed line) using the radius tool 10, the free end 13, 15, 17 of at least one arm 12, 14, 16, respectively, is engaged (with the arms spread to space the free ends angularly, as shown) upon the arch surface 26. The arms 12, 14, 16, with the pivot pin 24 in slots 18, 20, 22, are adjusted lengthwise relative to the pivot axis, A, until the free ends of all the arms are engaged upon the surface, and an indicator 28 on the pivot pin 24 is aligned with the same dimension on each of the arms. This dimension is representative of the length of radius of the archway surface.

In another embodiment of the invention (FIGS. 2 and 2A), a radius tool 10′ has gear teeth 40 defined along opposed edges of the elongated slot 18′, 20′, 22′, of each arm 12′, 14′, 16′, respectively, and a pivot pin 24′ defining a pinion gear 42 with teeth 44 cooperatively engaged in the gear teeth 40. The arms 12′, 14′, 16′ are assembled with the pinion gear 42, with an indicator 28′ aligned with the same dimension on each of the arms, so rotation of the pinion gear maintains the equal length of the arms extending from the axis, A′, of the pinion gear.

To determine the radius of a doorway arch using the radius tool 10′, the free ends of two arms, e.g. free ends 13′, 15′ of arms 12′, 14′, respectively, are engaged on the arch surface (not shown) at spaced apart positions. The pinion gear 42 is then rotated until the free end of the third arm, e.g. free end 17′ of arm 16′, engages the arch surface 26, at which point the indicator 28′ on the pinion gear 42 is aligned with the dimension representative of the length of radius of the archway surface.

In another embodiment of the invention (FIG. 3), a radius tool 50, suitable for measurement of larger radii, e.g., for laying out arcs and circles on athletics fields, has arms 52, 54, 56 in the form of flexible tapes wound from a spool 58 within a case 60 using a knob 62.

A number of embodiments of the invention have been described. Nevertheless, it will be understood that various modifications may be made without departing from the spirit and scope of the invention. Accordingly, other embodiments are within the scope of the following claims.

What is claimed is:

1. A tool for determining length of radius for an arc or circle, said tool comprising at least three arms joined at a region of intersection along respective lengths of said at least three arms by a pivot member defining a pivot axis,
each arm of said at least three arms having an elongated body with a free end, and
each arm of said at least three arms being disposed in lengthwise adjustable relationship with said pivot member, and
said tool further comprising an indicator of the length of radius measured along at least one arm of said at least three arms between said pivot axis and said free end of said at least one arm.

2. The tool of claim 1, wherein at least one arm of said at least three arms is adjustable lengthwise relative to said pivot axis independent of at least one other arm of said at least three arms.

3. The tool of claim 2, wherein each arm of said at least three arms is adjustable lengthwise relative to said pivot axis independent of each other arm of said at least three arms.

4. The tool of claim 3, wherein each arm of said at least three arms bears indicia of length measured from its respective free end.

5. The tool of claim 3, wherein each arm of said at least three arms defines an elongated slot, and said pivot member comprises a pivot pin engaged in said slot of each arm of said at least three arms.

6. The tool of claim 1, wherein said at least three arms are adjustable lengthwise in unison relative to said pivot axis.

7. The tool of claim 6, wherein said pivot member comprises an indicator of the length of radius measured between said pivot axis at a position of said pivot member along at least one arm of said at least three arms and said free end of said at least one arm.

8. The tool of claim 6, wherein each one of said at least three arms defines an elongated slot, and said pivot member comprises a pivot pin engaged in said slot of each arm of said at least three arms.

9. The tool of claim 8, wherein said slot of each said arm of said at least three arms further defines slot teeth disposed along said slot, and said pivot pin further defines pin teeth for cooperative interengagement with said slot teeth, whereby rotation of said pivot pin within said slots changes position of said pivot member along each arm of said at least three arms, in unison varying the length of each arm of said at least three arms from said pivot axis to the respective said free ends.

10. The tool of claim 1, wherein at least one arm of said at least three arms is pivotable about said pivot axis relative to and independent of at least one other arm of said at least three arms.

11. The tool of claim 1, wherein each arm of said at least three arms is pivotable about said pivot axis relative to and independent of each other arm of said at least three arms.

12. The tool of claim 1, wherein at least one arm of said at least three arms bears indicia of length measured from its respective said free end.

13. The tool of claim 1, wherein each arm of said at least three arms bears indicia of length measured from its respective free end.

14. The tool of claim 1, wherein said pivot member comprises an indicator of length measured between said pivot axis at a position of said pivot member along at least one arm of said at least three arms and said free end of said at least one arm.

15. The tool of claim 1, wherein each one of said at least three arms defines an elongated slot, and said pivot member comprises a pivot pin engaged in said slot of each arm of said at least three arms.

16. The tool of claim 15, wherein said slot of each said arm of said at least three arms further defines slot teeth disposed along said slot, and said pivot member further defines pin teeth for cooperative interengagement with said slot teeth, whereby rotation of said pivot pin within said slots changes position of said pivot member along each arm of said at least three arms, in unison varying the length of each arm of said at least three arms from said pivot axis to the respective said free ends.

17. The tool of claim 1, wherein each arm of said at least three arms is flexible.

18. The tool of claim 17, wherein said pivot pin comprises a spool and rotation of said pivot pin changes position of said pivot member along each arm of said at least three arms, in unison varying the length of each arm of said at least three arms from said pivot axis to the respective said free ends.

19. A tool for determining length of radius for an arc or circle, said tool comprising at least three arms joined at a region of intersection along respective lengths by pivot member defining a pivot axis,
each arm of said at least three arms having an elongated body with a free end, and
each arm of said at least three arms being disposed in lengthwise adjustable relationship with said pivot member,
each arm of said at least three arms being adjustable lengthwise relative to said pivot axis independent of each other arm of said at least three arms;
each arm of said at least three arms bearing indicia of length measured from its respective free end; and
each arm of said at least three arms defining an elongated slot, and said pivot member comprising a pivot pin engaged in said slot of each arm of said at least three arms; and
said tool further comprising an indicator of length of radius measured along at least one arm of said at least three arms between said pivot axis and said free end of said at least one arm.

20. A tool for determining length of radius for an arc or circle, said tool comprising at least three arms joined at a region of intersection along respective lengths by a pivot member defining a pivot axis,
each arm of said at least three arms having an elongated body with a free end, and
each arm of said at least three arms being disposed in lengthwise adjustable relationship with said pivot member, with said at least three arms being adjustable lengthwise in unison relative to said pivot axis;
each arm of said at least three arms defining an elongated slot, and said pivot member comprising a pivot pin engaged in said slot of each arm of said at least three arms, said slot of each said arm of said at least three arms further defining slot teeth disposed along said slot, and said pivot member further defines pin teeth for cooperative interengagement with said slot teeth, whereby rotation of said pivot pin within said slots changes position of said pivot member along each arm of said at least three arms, in unison varying the length of each arm of said at least three arms from said pivot axis to the respective said free ends;
said tool further comprising an indicator of length of radius measured along at least one arm of said at least three arms between said pivot axis and said free end of said at least one arm.

21. A tool for determining length of radius for an arc or circle, said tool comprising at least three arms joined at a region of intersection along respective lengths by a pivot member defining a pivot axis,
each arm of said at least three arms having an elongated body with a free end, and
each arm of said at least three arms being disposed in lengthwise adjustable relationship with said pivot member;
said at least three arms being adjustable lengthwise in unison relative to said pivot axis;
each arm of said at least three arms being flexible; and
said pivot member comprising a spool, whereby rotation of said pivot pin changes the relative position of said pivot member along each arm of said at least three arms, in unison varying the length of each arm of said at least three arms from said pivot axis to the respective said free ends;
said tool further comprising an indicator of length of radius measured along at least one arm of said at least three arms between said pivot axis and said free end of said at least one arm.

22. A method for determining length of radius for an arc or circle with a tool comprising at least three arms joined at a region of intersection along respective lengths by a pivot member defining a pivot axis, each arm of said at least three arms having an elongated body with a free end, and each arm of said at least three arms being disposed in lengthwise adjustable relationship with said pivot member, and said tool further comprising an indicator of length measured along at least one arm of said at least three arms between said pivot axis and said free end of said at least one arm, said method comprising the steps of:
placing the free end of at least one arm on an arc or circle for which length of radius is to be determined;
adjusting the arms lengthwise relative to the pivot member until the free ends of the three arms are on the arc or circle and the lengths of three arms from the free end to the pivot axis are substantially equal; and
determining the length of radius from the common length of the three arms.
